(19) United States
(12) Patent Application Publication
(10) Pub. No.: US 2025/0012902 A1
(43) Pub. Date: Jan. 9, 2025

(54) TIME-OF-FLIGHT CIRCUITRY AND TIME-OF-FLIGHT METHOD

(71) Applicant: Sony Semiconductor Solutions Corporation, Atsugi-shi, Kanagawa (JP)

(72) Inventors: Maarten KUIJK, Stuttgart (DE); Daniel VAN NIEUWENHOVE, Stuttgart (DE); Morin DEHAN, Stuttgart (DE); Gobinath JEGANNATHAN, Stuttgart (DE)

(73) Assignee: Sony Semiconductor Solutions Corporation, Atsugi-shi, Kanagawa (JP)

(21) Appl. No.: 18/709,816

(22) PCT Filed: Nov. 21, 2022
(86) PCT No.: PCT/EP2022/082574

§ 371 Date: May 14, 2024

(30) Foreign Application Priority Data
Nov. 26, 2021 (EP) 21210707.2

(51) Int. Cl. G01S 7/4865; G01S 7/481; G01S 17/10

(52) U.S. Cl. CPC G01S 7/4865; G01S 7/4816; G01S 17/10

(57) ABSTRACT

The present disclosure generally pertains to time-of-flight circuitry for determining a roundtrip delay of photons emitted by a light source and incident on a time-of-flight imaging element, the time-of-flight circuitry being configured to: determine a test number of photons at a test point of time and a reference number of photons at a reference point of time, the test point of time and the reference point of time being included in a measurement time interval of at least two measurement time intervals for which the test point of time is varied; and compare, for determining the roundtrip delay of the emitted photons, the test number of photons with the reference number of photons.

### TECHNICAL FIELD

The present disclosure generally pertains to time-of-flight circuitry and a time-of-flight method for direct time-of-flight.

### TECHNICAL BACKGROUND

Generally, time-of-flight (ToF) devices are known. It may be distinguished between iToF (indirect ToF) and dToF (direct ToF). In iToF, a distance may be indirectly measured based on a phase-shift of emitted light compared to detected light.

In dToF, the distance may be directly measured by determining a roundtrip delay of emitted light. dToF may be based on diode technology, such as a SPAD (single photon avalanche diode).

Besides being capable to detect single photons, SPADs may have an inherent property that the time of photon arrival is known. In several publications, SPADs are proposed to be used for distance detection, i.e. for lidar and 3D camera applications.

In dToF, a histogram may be generated which indicates a number of photons and their respective arrival times.

Although there exist techniques for dToF, it is generally desirable to provide ToF circuitry and a ToF method.

### SUMMARY

According to a first aspect, the disclosure provides time-of-flight circuitry for determining a roundtrip delay of photons emitted by a light source and incident on a time-of-flight imaging element, the time-of-flight circuitry being configured to:
determine a test number of photons at a test point of time and a reference number of photons at a reference point of time, the test point of time and the reference point of time being included in a measurement time interval of at least two measurement time intervals for which the test point of time is varied; and
compare, for determining the roundtrip delay of the emitted photons, the test number of photons with the reference number of photons.

According to a second aspect, the disclosure provides a time-of-flight method for determining a roundtrip delay of photons emitted by a light source and incident on a time-of-flight imaging element, the method comprising:
determining a test number of photons at a test point of time and a reference number of photons at a reference point of time, the test point of time and the reference point of time being included in a measurement time interval of at least two measurement time intervals for which the test point of time is varied; and
comparing, for determining the roundtrip delay of the emitted photons, the test number of photons with the reference number of photons.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows a timing diagram according to the present disclosure;

FIG. 2 shows a TOF receiver according to the present disclosure, wherein a confidence signal is constructed by an up/down counter;

FIG. 3 shows a TOF receiver according to the present disclosure, wherein a confidence signal is constructed by a switch-cap averaging system;

FIG. 4 shows a numerical statistical simulation based on the ToF receiver of FIG. 3;

FIG. 5 shows a ToF method according to the present disclosure;

FIG. 6 show a flip-flop according to the present disclosure for determining an object distance;

FIG. 7 is an embodiment of a time-of-flight method according to the present disclosure; and

FIG. 8 is a further embodiment of a time-of-flight method according to the present disclosure in which further a confidence value is adapted.

### DETAILED DESCRIPTION OF EMBODIMENTS

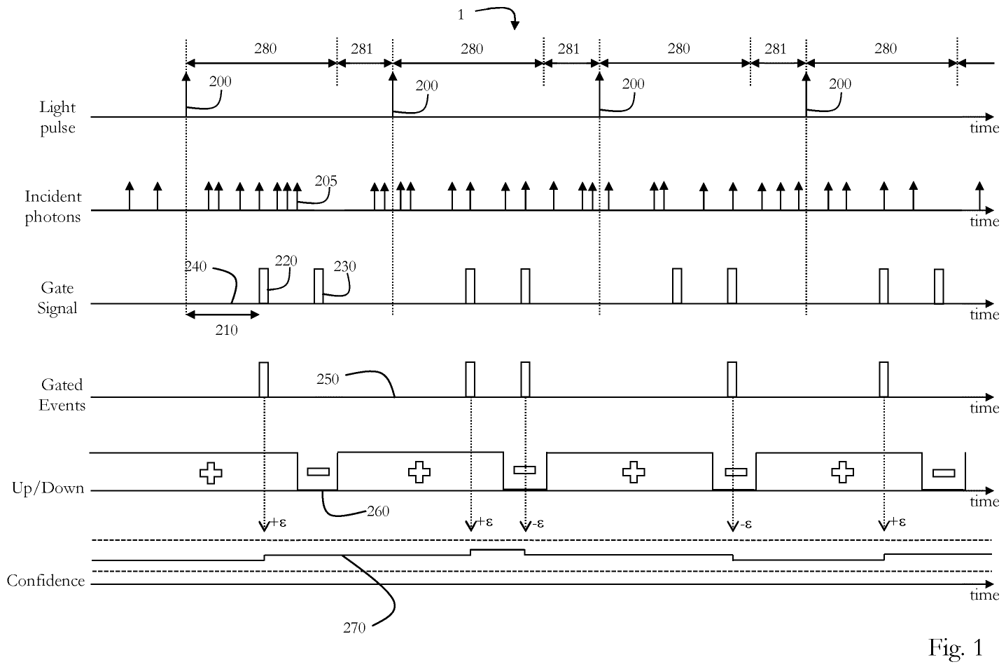

Before a detailed description of the embodiments starting with FIG. 1 is given, general explanations are made.

As mentioned in the outset, direct time-of-flight (dToF) methods and devices are generally known. They may employ SPAD (single photon avalanche diode) technology. However, it has been recognized that SPADs may also trigger on thermally generated minority carriers in the semiconductor, or on tunneling of carriers, also called dark count rate (DCR). Moreover, when light is incident on a ToF receiver, the incident photons may correspond to emitted (or correlated) photons (ToF photons), stemming from reflections in a scene of a pulsed laser light source, or they may correspond to uncorrelated photons, e.g., from ambient light (AL) reflected on the target area in the scene. In known dToF systems, by making a histogram of the arrival times, a constant level for the sum of AL and DCR may be obtained, and a peak, correlated with the TOF arrival moment.

Making many simultaneous histograms for array operation may be carried out for a low number of pixels (e.g. a linear array of pixels, or for a limited resolution array of pixels): a moment in time using counters to achieve time to digital conversion (TDC) may be recorded, communicate this data to a digital signal processor (DSP) to achieve histogram build-up and finally threshold for estimating the distance. However, when scaling to higher resolutions and/or high AL levels, data-congestion and higher power dissipation may be challenging.

It has thus been recognized that it may be desirable to provide for a small circuit that can be integrated on a per pixel base, and that may be adapted to interpret incoming time-of-flight and ambient light photons.

It has been recognized that this may be achieved by consecutively assuming a range of distances to be an object distance, during which each of these assumed distances get evaluated based on a confidence signal that is constructed from the occurring incident photon rate at that distance. When there is not enough confidence, the next distance may be considered. Many positions may be (quickly) scanned such that within a reasonable time, the real distance may be found, which may be indicated by a high confidence signal.

Moreover, it has been recognized that a power reduction may be achieved by lowering a number of measurement cycles per second, while keeping the confidence level up to date.

For example, once the confidence flags a change in distance, or when in array operation, many pixels in the same illumination zone flag such a change, the number of measurement cycles per second may swiftly be increased to adapt to the reality of the changing scene, updating to the new scene. By considering one assumed distance at a time, many incoming photons may just be ignored, such that a twenty to hundred-fold reduction of SPAD power dissipation may be achieved. By keeping the SPAD in a quenched position most of the time, dead time may become less relevant. Also, effects of photon pile-up may get reduced according to the present disclosure.

The distance determination in the pixels may further be complemented with data communication to a DSP with a comparable image data transfer rate as with standard 2D image sensors. Compared to other systems of signal demodulation in pixels (e.g. the current assisted photonic demodulator (CAPD)), it may not be necessary to work with different measurement frames that each need to be recorded consecutively.

Hence, according to the present disclosure, a 3D ToF image sensor may be provided which may be fabricated with a single layer of electronics, but that can also be implemented in a 3D-stacked configuration, wherein several semiconductor layers are stacked for different functionality, like a detection layer for the SPADs and a layer for the subsequent data processing.

Therefore, some embodiments pertain to time-of-flight circuitry for determining a roundtrip delay of photons emitted by a light source and incident on a time-of-flight imaging element, the time-of-flight circuitry being configured to: determine a test number of photons at a test point of time and a reference number of photons at a reference point of time, the test point of time and the reference point of time being included in a measurement time interval of at least two measurement time intervals for which the test point of time is varied; and compare, for determining the roundtrip delay of the emitted photons, the test number of photons with the reference number of photons.

Circuitry may pertain to any entity or multitude of entities configured to carry out a time-of-flight measurement based on which a roundtrip delay may be determined, such as direct ToF.

The circuitry may be based on or include one or multiple processors (e.g. CPU (central processing unit), GPUs (graphics processing unit)), FPGAs (field-programmable gate array), ToF cameras, computers, servers, or the like.

The circuitry may be adapted to control the light source and/or the imaging element, whereas in other embodiments, the circuitry may only evaluate the results, i.e., in such embodiments the light source and/or the imaging element may be controlled by another entity.

Generally, the light source may be configured to emit pulsed light and may be based on laser technology, for example, such as VCSELs (vertical cavity surface emitting laser), laser diodes, or

LED (light emitting diode) technology, or the like. The light source may include multiple light emitting elements which may be arranged in an array. A number of light emitting elements of the light source may be in a relation with a number of imaging elements of a ToF image sensor, wherein the relation may be any relation, but the present disclosure is not limited to such cases.

The imaging element may be based on SPAD technology (single photon avalanche diode) or any other technology which may allow for single photon counting, such as an avalanche photodiode (APD) which may be correspondingly biased (as will be discussed below), or the like.

According to the present disclosure, the roundtrip delay may be measured directly, i.e. a time may be directly determined by the ToF circuitry which may be indicative of a distance the photons have travelled from the light source and back to the ToF imaging element.

In order to carry out such a measurement, a test number of photons may be determined at a test point of time. The test point of time may be any point of time (in a measurement time interval (e.g. a frame)) for which it is tested whether the emitted photons are detected by the imaging element. The test point of time may be determined based on a rough distance assumption, based on a time sweeping, or the like. Hence, the test point of time may be varied from measurement time interval to measurement time interval.

For example, in case that no photon is detected at the test point of time, the test point of time may be a different one in the next frame (or the same one, in order to make sure that also at the next measurement time interval, no light will be detected).

Moreover, in some embodiments, a reference number of photons may be determined at a reference point of time. The reference point of time may be any point of time (in the measurement time interval) for which it is assumed that at this point of time, the emitted photons are not detected in the imaging element. Hence, a distance between the test point of time and the reference point of time may be appropriately high.

According to the present disclosure, the test point of time may lie before the reference point of time in each measurement time interval or vice versa. Also, the ordering of the test point of time and the reference point of time may be varied from measurement time interval to measurement time interval.

However, it is not necessary that the test point of time is varied in each measurement time interval and it may be sufficient to vary it only once (i.e. that it is different in two measurement time intervals).

In some embodiments, the test number of photons is compared with the reference number of photons. Thereby, the roundtrip delay of the emitted photons may be determined.

For example, if in one frame, the test number of photons is higher (by a predetermined number) than the reference number of photons, it may be determined that the test point of time (with respect to a light emission point of time) corresponds (roughly) to the roundtrip delay (wherein a calibration may be carried out to single out influence of electronics, and the like). However, multiple measurement time intervals may be considered in which the test number of photons should be higher than the reference number of photons.

For example, if single photons are counted, it may be determined that the test point of time corresponds to the roundtrip delay when the test number of photons is one and the reference number of photons is zero. If such a relation is determined in multiple (consecutive) measurement time intervals, the test point of time (with respect to a light emission point of time) may be indicative of the roundtrip delay.

Generally, the test point of time and the reference point of time may be indicative of time intervals (e.g. test time interval and reference time interval) and may be generated by controlling a gate for a very short (e.g. in a picosecond range) time period (time interval). The time interval length may be that short that it is possible to detect only one photon (or any other predetermined number of photons) in the respective time interval. Hence, although the term “point of time” refers to a (very short) “time interval”, it may be appreciated by the skilled person that in the present specification, the term “point of time” is used.

In some embodiments, the test number of photons is indicative of the emitted photons, as discussed herein. It should be noted that the test number of photons may not represent all the emitted photons, in some embodiments, but may be indicative for an emitted photon being detected at the test point of time.

In some embodiments, the reference number of photons is indicative of ambient light.

Generally, if a photon is detected at the reference point of time, ambient light may not be the only source. For example, statistic noise, such as sensor noise, dark counts, or the like may be such sources. However, it should be noted that the present disclosure may be applicable when ambient light is above a predetermined threshold, e.g., under such circumstances at which known dToF systems typically may not be able to properly operate (e.g. bright daylight).

In some embodiments, the test number of photons is either zero or one.

This may be the case when single photons are counted and may also apply to the reference number of photons, as discussed above.

In some embodiments, the test point of time is based on a test gate signal which constitutes a test time interval and wherein the reference point of time is based on a reference gate signal which constitutes a reference time interval, as discussed herein.

In some embodiments, the time-of-flight circuitry is further configured to: change a confidence value based on the comparison of the test number of photons with the reference number of photons.

As has been laid out above, one measurement time interval may not be sufficient, in some embodiments, to make sure that the test point of time really represents the roundtrip delay. This may be the case when single photons are counted. However, also for multiple photons being counted, such a scheme may be employed.

In such embodiments, a confidence value may be defined which may be preset to a specific value. If the confidence value exceeds a predetermined threshold, the test point of time may be determined to represent the roundtrip delay.

If there is a photon counted at the test point of time, the confidence may be increased by a predetermined amount and if a photon is counted at the reference point of time, the confidence may be decreased by the predetermined amount (or a different amount, depending on whether the two events are regarded as equally important). Accordingly, if at both points of time, one or no photons are counted, the net value of the confidence after the measurement time interval remains the same as before (although within the measurement time interval it may be increased and decreased consecutively, but this may depend on the specific implementation).

Hence, in some embodiments, the time-of-flight circuitry is further configured to: increase the confidence value, if the test number of photons is larger than the reference number of photons; and/or decrease the confidence value, if the reference number of photons is larger than the test number of photons.

In some embodiments, the time-of-flight circuitry is further configured to: determine the roundtrip delay if the confidence value exceeds a predetermined threshold, as discussed herein.

In some embodiments, the time-of-flight circuitry is further configured to: vary the test point of time, if the test number of photons is below a predetermined threshold.

For example, the test point of time may be assumed to represent the roundtrip delay for a predetermined number of measurement time intervals. When it is made sure that this is not the case (i.e. based on the confidence), the test point of time may be varied. However, the present disclosure is not limited to that case since the variation of the test point of time may be based on a sweeping, or the like, as has been laid out above. Also a mixture of different methods of varying the test point of time may be employed.

In some embodiments, the time-of-flight imaging element is based on a single photon avalanche diode, as discussed herein.

In some embodiments, the ToF circuitry further includes a delay generator for generating the test point of time and/or the reference point of time.

There are many ways that a delay generator may operate according to the present disclosure. It may, for example, linearly (or non-linearly) sweep through a full distance (or time) range, going from close by, up to far away, or vice versa going from far away to close by. It may modulate the step-width, depending on the distance, e.g. making the steps smaller between consecutive distances, for the longer distances. Far away objects will generate a smaller time-of-flight light photon flux, and by making smaller steps, weaker signals are less likely to be stepped over. It is also possible to fix the distance in e.g., a hundred pieces as to obtain about a one percent precise time-of-flight distance.

In some embodiments, when all distances have been trialed, the searching process is continued, either by doing the same sequence or e.g. an opposite one. In some cases, a random or pseudo random sequence is applied in the searching space. It is also possible that a signal is given to the delay generator though an additional input port (not shown) for modification by a DSP, for optimization purposes. It can, for example be envisaged that only a limited portion of the distances is to be searched. It is further also possible that very short distances are skipped by default, to avoid locking on the reflections in a lens that is shared between the outgoing and incident light flux.

In some embodiments, a border between a match and no match may be adapted. For example, during a period an excess number of ambient photons may be incident during the measurement periods (as compared to the reference period), delaying an advancement to a next trial distance. If the confidence value is read out at that moment, it may be just above a predetermined voltage value (e.g. five-hundred millivolts), but it may not be sufficiently above the predetermined voltage to determine the roundtrip delay. Hence, depending on the application and/or the level of ambient light, the border may be adapted. If ToF light levels are relatively low (or a distance is relatively high) (relatively: depending on the usual application), the system might not sufficiently work. However, according to the present disclosure, the confidence may be kept sufficiently low in uncertain situations.

In some embodiments, an offset is applied for distinguishing between match and no match. An offset may correspond to a kind of imbalance that has to be overcome before an existence of a match is determined. According to the present disclosure, there are several ways to generate such an offset. A first one is to make ref-gates (e.g., reference time interval or reference point of time, as discussed herein, see e.g., description of FIGS. 1 to 3) wider, e.g., ten percent, than test-gates (e.g., test time interval or test point of time, as discussed herein, see e.g., description of FIGS. 1 to 3). As a result, in the case that the assumed distance does not match the real distance, more counts are obtained on average in a downward direction. It may generate a threshold that requires the over-amount of ambient photons in case of a match, to outnumber by available time-of-flight photons in the test-gate window. The required absolute number of time-of-flight events may then be scaling in proportion with the ambient light level. Another option for generation of an offset may include setting a threshold at a certain level. Yet another option may include that the timing generator generates a different number of test-gates and ref-gates to generate an imbalance.

A further option is to use a different value for increasing the confidence than for decreasing it.

For example, when using a switch capacitor circuit (as will be discussed below), if a reference period is larger than a test period (e.g., ten percent larger, in case of five-hundred millivolts, it may be changed to four-hundred-fifty millivolts), an imbalance may be introduced such that a ToF system is more stabilized. In such embodiments, there may be no need of an additional circuit in a pixel and such embodiments may be applicable for a whole pixel array.

All or some of these options may be combined as well.

In some embodiments, an averaging level is modified. For instance, it is averaged over a large number of events, e.g. like over a thousand events, ambient and time-of-flight events, in that way, having a confidence level that is less wildly going up and down under a high ambient light level. To this end, between an averaging means and a comparator, a second averaging, or low pass filter can be applied, being e.g., a FIR filter, an analog filter, or the like.

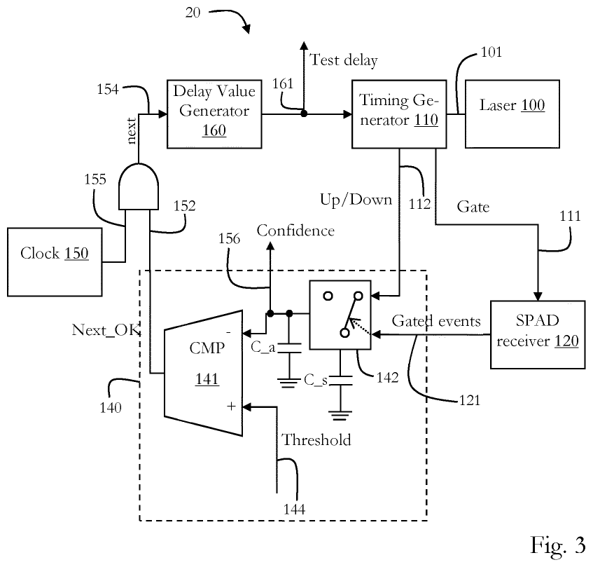

In some embodiments, the time-of-flight circuitry further includes a switched capacitor averaging circuit including an averaging capacitor, a sampling capacitor, and a switch for switching between the averaging capacitor and the sampling capacitor, for comparing the test number of photons with the reference number of photons, as will be discussed under reference of FIG. 3.

Hence, in some embodiments, the time-of-flight circuitry is further configured to control the switch to switch between the averaging capacitor and the sampling capacitor.

In some embodiments, the switched capacitor averaging circuit is further configured to carry out exponential moving averaging based on a ratio between an averaging capacitor capacitance (a capacitance of the averaging capacitor) and a sampling capacitor capacitance (a capacitance of the sampling capacitor).

Some embodiments pertain to a time-of-flight method for determining a roundtrip delay of photons emitted by a light source and incident on a time-of-flight imaging element, the method including: determining a test number of photons at a test point of time and a reference number of photons at a reference point of time, the test point of time and the reference point of time being included in a measurement time interval of at least two measurement time intervals for which the test point of time is varied; and comparing, for determining the roundtrip delay of the emitted photons, the test number of photons with the reference number of photons, as discussed herein.

The ToF method may be carried out by ToF circuitry according to the present disclosure.

In some embodiments, the test number of photons is indicative of the emitted photons, as discussed herein. In some embodiments, the reference number of photons is indicative of ambient light, as discussed herein. In some embodiments, the test number of photons is either zero or one, as discussed herein. In some embodiments, the test point of time is based on a test gate signal which constitutes a test time interval and wherein the reference point of time is based on a reference gate signal which constitutes a reference time interval, as discussed herein. In some embodiments, the time-of-flight further includes: changing a confidence value based on the comparison of the test number of photons with the reference number of photons, as discussed herein. In some embodiments, the time-of-flight method further includes: increasing the confidence value, if the test number of photons is larger than the reference number of photons; and/or decreasing the confidence value, if the reference number of photons is larger than the test number of photons, as discussed herein. In some embodiments, the time-of-flight method further includes: determining the roundtrip delay if the confidence value exceeds a predetermined threshold, as discussed herein. In some embodiments, the time-of-flight method further includes: varying the test point of time, if the test number of photons is below a predetermined threshold, as discussed herein. In some embodiments, the time-of-flight imaging element is based on a single photon avalanche diode, as discussed herein. In some embodiments, the time-of-flight method further includes switching between an averaging capacitor and a sampling capacitor for comparing the test number of photons with the reference number of photons, as discussed herein. In some embodiment, the time-of-flight method further includes controlling a switch for switching between the averaging capacitor and the sampling capacitor, as discussed herein. In some embodiments, the time-of-flight method further includes carrying out exponential moving averaging based on a ratio between an averaging capacitor capacitance and a sampling capacitor capacitance, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Some embodiments pertain to a ToF receiver for estimating a distance including a SPAD circuit for generating an event upon detection of a photon; a switch control circuit for generating a first signal for sampling a modulation voltage, a second signal for including the sample into an average output; an averaging demodulator that has a demodulation voltage applied at its input node, that in response to the first signal is configured to sample this demodulation voltage, in response to the second signal includes this sample in its output voltage on a node for estimation of a TOF-distance.

Returning to FIG. 1, there is depicted a timing diagram 1 according to the present disclosure.

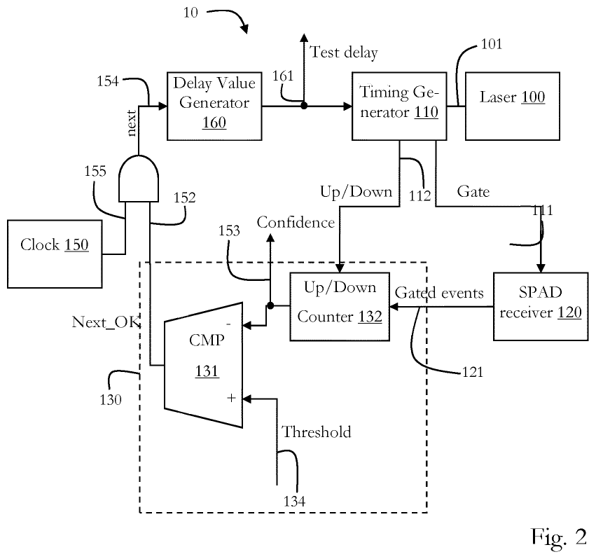

Moreover, FIGS. 2 and 3 depict exemplary embodiments of ToF systems 10 (FIG. 2) and 20 (FIG. 3) including ToF circuitry 130 (FIG. 2) and 140 (FIG. 3) according to the present disclosure based on which the timing diagram is further explained.

The timing diagram 1 shows signals versus time for explaining the principles of the present disclosure. Consecutive measurement cycles are run, each starting with a light pulse 200 emitted by a laser 100 (or LED, in other embodiments) to a scene (not depicted). Between these cycles 280, there is a temporal break 281, demonstrating that measurement cycles are not abutted in time, in this embodiment. However, in other embodiments, at least a subset of measurement cycles is abutted.

The breaks 281 have the same length, in this embodiment, but generally they may be of a constant or variable nature.

Reasons to make them variable may include lowering the power dissipation and randomizing the emitted output light so as to accommodate multiple 3D camera systems to operate on the same scene, rendering the laser output of another camera to be interpreted as uncorrelated with its own laser output, similar to ambient light and thereby reducing interference. A break may be of any length and as long as wanted for lowering power dissipation.

Photons 205 are incident to the SPAD receiver 120. Some photons originate from ambient light on the scene and some photons are present due to the pulsed illumination 200 being reflected on the scene.

For example, ambient light photons may be ten to a thousand times higher than emitted photons (even after spectral filtering) without limiting the present disclosure in that regard.

A gate signal 111 is constructed in time, shown as curve 240. The gate signal 111 includes two types of gate windows that can appear in the measurement cycles 280. A gate window is a short period in time during which the SPAD-receiver 120 is requested to check whether there is a photon incident. If so, the SPAD receiver 120 signals through its output 121 that a photon was incident, else it keeps its output 121 silent. Dark count signals can also happen during said windows and have similar properties as incident ambient light photons and dark counts and dark count rate (DCR) are therefore ignored in the subsequent text.

A test-delay period 210 is determined, representative for an assumed distance to the scene. This test-delay 210 is referred to the beginning of the measurement cycle 280 starting with a light pulse 200. After the test-delay period 210, a test-gate window 220 (test time interval) opens for a short period (test point of time) (in this embodiment fifty picoseconds, but generally the test time interval may have any length, e.g. between fifty picosecond and several nanoseconds). The SPAD receiver 120 is requested to check whether a photon is incident during this test-gate window 220.

A ref-gate window 230 (reference time interval) opens for a short period (reference point of time) (in this embodiment fifty picoseconds, but generally the test time interval may have any length, e.g. between fifty picosecond and several nanoseconds). The SPAD receiver 120 is then requested to check whether a photon is incident during this ref-gate window 220.

Gated events 121, curve 250, stemming from the SPAD receiver 120, signal the presence of photons during the window periods that the SPAD-receiver 120 was requested to be sensitive, i.e., during the period that gate-signal 111 is high.

A timing generator 110 is configured to generate the gate signal 111, and to provide for a signal up/down 112, signaling whether the gate window was either a test-gate window 220 or a ref-gate window 230.

When the assumed distance, corresponding to test-delay period 210 is not coinciding with the real distance, no time-of-flight photons will be present in the test-gate window 220, leaving only ambient photons to generate part of the gated events 121. By comparing the rate or number of events originating from the test-gate 220 with the ref-gate 230, comparable numbers/rates of events may be obtained demonstrating that there is no light incident correlated with the emitted light pulse 200.

When the assumed distance, corresponding to test-delay period 210 is however coinciding with the real or approximate distance, most of the incident time-of-flight photons 172 will be present in the test-gate window 220, on top of the ambient photons to generate part of gated events 121. By comparing the rate or number of events originating from the test-gate 220 with the ref-gate 230, a considerable higher numbers/rates of events is yielded demonstrating that light is incident, correlated with the emitted light pulse 200, which demonstrates that the correct distance is being assumed and under test.

In FIG. 2, the comparison is made by using an up/down counter 132, that in response to the digital up/down signal 112 (curve 260 in FIG. 1) will count upwards or downwards at each gated event 121.

When a match in distance is performed, the ambient photons in both test windows will cancel each other out, and the time-of-flight photons 172 will generate gated events during the test-gate 220 only, and as such the counter 132 will go up. This digital value, or a part of it can be signaled to the DSP as the confidence signal 153. The counter can be of limited number of bits, including six, eight, ten, twelve, or sixteen without limiting the present disclosure in that regard.

In some embodiments, the counter is designed such that it cannot overflow, i.e., that once its maximum positive value is reached and then when further up-wards counting is requested, that it stays limited to its maximum level (and not folding to the most negative value). A threshold level 134 may be used to determine where the boundary is located for considering a possible distance match.

In FIG. 3, the comparison is made by a switched capacitor averaging circuit, including a switch 142, an averaging capacitor C_a and a sampling capacitor C_s generating an analog confidence signal 156.

A threshold level 144 is used to determine where the boundary is located for considering a possible distance match. If there is no match, statistically same numbers and rates of events originate during test-gates 220 when up/down is high (e.g., one volt), as during ref-gates 230, when up/down signal 112 is driven low (e.g., zero volt) by the timing generator 110. Assuming C_a is n-times larger than C_s, an exponential moving averaging is performed on the one volt and zero volt input signals. Roughly, an averaging is then performed over the last C_a/C_s number of samples. When on average the same number of occurrences are present (i.e., in the case of no distance matching) the average output voltage, constituting the confidence signal 156 is close to halfway between the high and low voltage value of the up/down signal 112. When the digital voltage values of the up/down signal 112 are 1V and 0V for high and low respectively, the average voltage will then be close to five hundred millivolts.

Curve 270 (in FIG. 1) shows the updating of the confidence level by small amounts, sometimes upwards (in case the event is during a test-gate window 220, and sometimes downwards (in case the event is during a ref-gate window 230).

In FIGS. 2 and 3, out of comparator 132 and 141 respectively comes a signal Next_OK 152 that remains low when there is indication of a possible distance match, and that it is therefore not approved to step to a next assumed distance and thus not to update the test-delay signal 161 nor to change the test-delay period 220.

When however, the Next_OK signal 152 becomes high, it is considered that the confidence of a match is low enough to advance to a next position. A clock 150 generates a signal 155, defining moments in time that the Next_OK signal 152 is evaluated, and effectively a next assumed distance can be instigated. If this is the case, signal next 154 passes this message through a pulse or edge to delay value generator 160 for updating the test-delay signal 161 that is used by the timing generator 110 to apply for an updated dets-delay 210 during the measurements to follow. The number of measurement cycles 280 that pass before this evaluation is made can be between several hundreds to millions of measurement cycles. The higher this number of measurement cycles is used to evaluate the confidence, the more considerate the decision is taken, but also, the longer it takes before an update can take place. The delay value generator 160 is configured to, each time it receives a next signal 154, come up with an adapted assumed distance, reflected in an associated test-delay signal 161. Timing generator 110 will use the latter signal to apply the associated test-delay period 210. The delay-value generator 160 proposes each time it is instigated at its input by the next signal 154, a new test-delay signal 161.

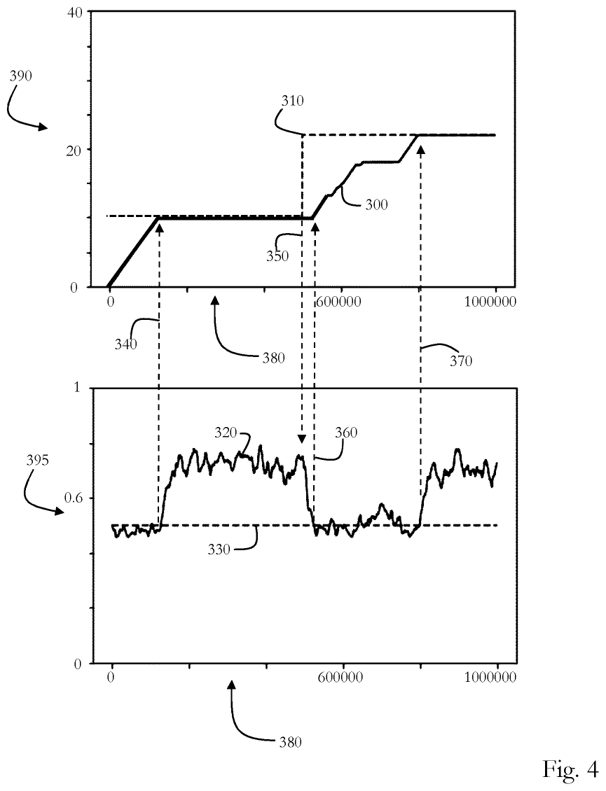

FIG. 4 gives a statistical simulation over a period of one million measurement cycles of forty nanosecond each, in total forty milliseconds. It is based on the analog principle 140 (FIG. 3) for generating confidence, with an averaging length C_a/C_s of one thousand six hundred, an average ambient photon event rate of one photon per two hundred nanoseconds, and only having on average four time-of-flight photons per thousand measurement cycles (four photons per forty microseconds). The width of the test-gates and ref-gates signals are both five hundred picoseconds.

The emitted light pulse FWHM (full width half maximum) is hundred picoseconds. The dashed line 310 is a ground truth period that starts at ten nanoseconds, and that steps halfway to twenty-two nanoseconds. The simulation starts with a test-delay period (curve 300) of zero nanoseconds.

Y-axis 390 goes from zero to forty nanoseconds. Y-axis 395 goes from zero to one for the confidence signal 320. The time axis 380 goes from zero to one million measurement cycles, i.e. up to forty milliseconds. The confidence moves around 0.5 when the test-delay period 300 is not coinciding with the ground truth 310. In this case, incremental steps are made, based on a decision clock 150 with frequency of hundred kilohertz, so every ten microseconds a small step can be allowed depending on the Next_OK 152 signal. The used threshold 144 is set to halfway, being five hundred millivolts. After some time, the test-delay period 300 reaches the ground truth 310, at which the confidence steeply rises, preventing further stepping of the test-delay 300. Then at half a million cycles the ground-truth is suddenly updated to twenty-three nanoseconds (emulating that an object moves place). From here onwards, there are on average as many up and down counts, bringing the confidence 320 to its middle value, where it sometimes resides above and sometimes below five hundred millivolts. At periods that it is above five hundred millivolts, the test-delay period 300 stops increasing, and when being below, the increase continues. Once arrived at twenty-two nanoseconds, the increase stops because the searched for ground truth 310 is found, since the confidence level is reaching five hundred millivolts.

At the moment of transition 340, lock is obtained, at moment of transition 350, the ground-truth changes, followed by a steep decline in confidence, once confidence is dropped below five hundred millivolts, test-delay period 300 starts increasing again, and when arrived at its final destination, transition 370, confidence rises significantly, because there is again a high number of time-of-flight photons detected in the test-gates 220 having at that moment the right test-delay period of twenty-two nanoseconds.

The described blocks in FIGS. 2 and 3 may be implemented in multiple ways according to the knowledge of the skilled person. Moreover, The SPAD receiver may have different implementations. For example, an excess bias may be applied at the gating moments and keep the SPAD below their break-down voltage in the remaining periods. Incident photons outside the gating periods will then only generate a minority carrier without generating breakdown, which may lower power dissipation by a large factor.

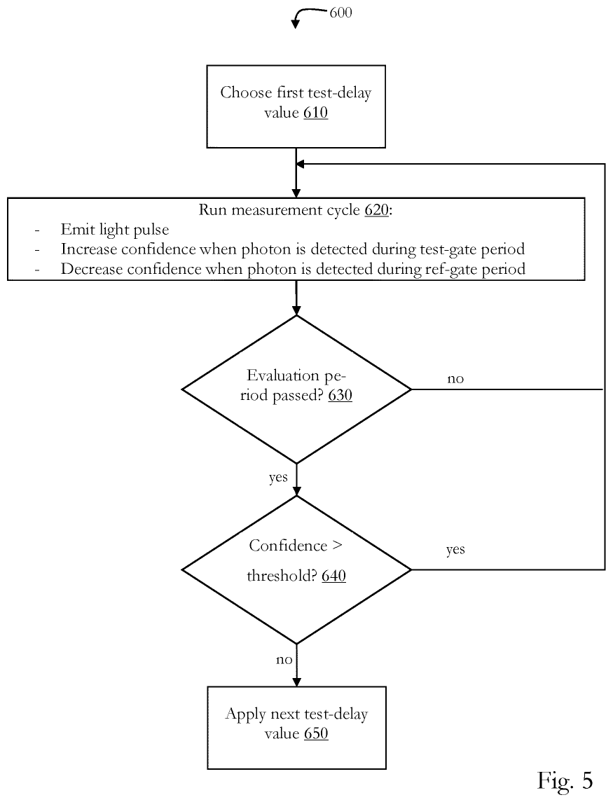

FIG. 5 shows a ToF method 600 according to the present disclosure.

At 610, a first test-delay is applied, after which a predetermined number of measurement cycles are run at 620, until an evaluation period is passed, determined by for example a clock 150. During each measurement cycle, light is emitted, and after a test-delay, a gate-window is opened, and a confidence signal is increased in case a photon is detected. During a ref-gate period, photons can decrease the confidence and in that way the rate and/or the number of events during the gating periods are compared.

At 630, it is decided whether an evaluation period has passed. If no, another measurement cycle is run.

If yes, it is checked whether the confidence is above a predetermined threshold, at 640.

If the number of events during which time-of-flight photons can enter is significantly higher, then a threshold is surpassed, and test-delays will no longer be updated.

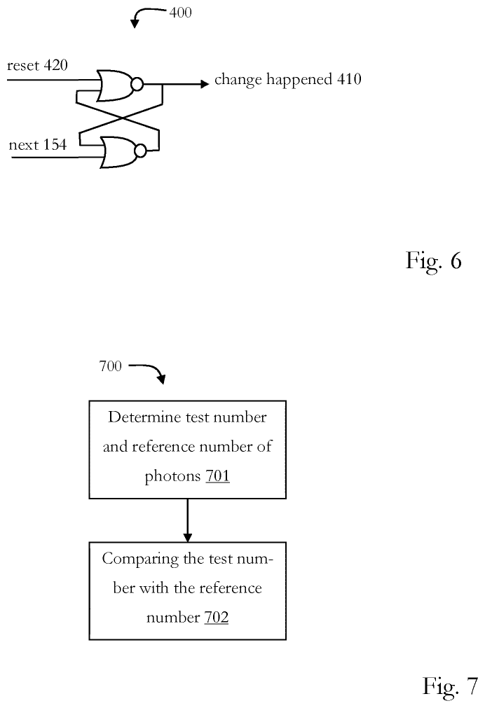

FIG. 6 depicts a flip-flop 400 for evaluation the object distance.

Generally, a digital signal processor can use the values of the test delay, or any derived value, to use as a measure for the object distance. Once it has read the latest value, it may set the flip-flop 400 through reset signal 420, such that the output bit indicating, whether “change happened” 410 is set low (e.g. “0”). If the distance of the object changes, next 154 will go high, thereby setting the output bit indicating, whether a change happened 410, accordingly, e.g. high (“1”). In this way the DSP may monitor whether one or multiple distances (from multiple systems 198, 199) have changed in a low power.

The circuits 10 and/or 20 may be repeated in 1D or 2D array to constitute an image sensor without limiting the present disclosure in that regard. The person skilled in the array may choose to keep certain parts common, e.g. the clock generation 150. Also a flip-flop 400 can be instantiated per pixel or per group of pixels to signal the DSP processor that a substantial change has happened possibly triggering a higher rate of measurement cycles 280, and possibly instigating other operations at the processing level. Read-out transistors as known in the art may be added to arrange the array operation adapted to the specific envisaged application.

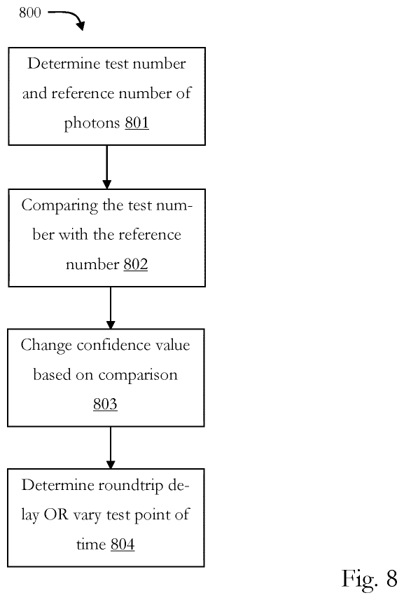

FIG. 7 depicts an embodiment of a ToF method 700 according to the present disclosure in a block diagram.

At 701, a test number of photons is determined at a test point of time and a reference number of photons is determined at a reference point of time, as discussed herein.

At 702, the test number is compared with the reference number, as discussed herein.

FIG. 8 depicts an embodiment of a ToF method 800 according to the present disclosure in a block diagram, in which further a confidence value is determined.

At 801, a test number of photons is determined at a test point of time and a reference number of photons is determined at a reference point of time, as discussed herein.

At 802, the test number is compared with the reference number, as discussed herein.

At 803, a confidence value is changed depending on a comparison result, as discussed herein. In this embodiment, the confidence value is changed based on an up/down counter. If the test number of photons is larger than the reference number of photons, the confidence value is increased, and the confidence value is decreased, if the reference number of photons is below the test number of photons.

At 804, if the confidence value exceeds a predetermined threshold, a roundtrip delay is determined. Otherwise, the test point of time is varied based on a sweep, as discussed herein.

Any of the systems that are presented here, or that are based on it, may be complemented by other means known in the state of the art of image sensors. For example, micro-lenses, color filters, or the like, may be applied in order to optimize the light input to the single photon detection circuit. Any means for improving the internal/external quantum efficiency, responsivity, and detection probability may be applied. Three-dimensional stacking may be done, e.g., wherein a SPAD detector layer may stem from another wafer/material then a CMOS circuit wafer. Back-side illumination (BSI) may be applied, current assistance may be applied or a Silicon On Insulator (SOI) technology may be applied. The proposed embodiments of the disclosure may be laid out as pixels for a sensor array, in total making a 3D image sensor. Several signals may be grouped for a plurality of pixels, or are the same for a whole array, like the ones defining the windows, demodulation functions, and signals determining the averaging-length n. In addition to all this, a standard 3T or 4T image sensor pixel may be added, for performing simultaneously standard image sensing. The SPAD receiver 120 may include a regular SPAD, but can also include any other means to achieve single photon detection, including an avalanche photodetector (APD) with sufficient gain, that a linear gain modus may be utilized to operate the diode below break-down and still achieve digital photon arrival edges and events.

It should be recognized that the embodiments describe methods with an exemplary ordering of method steps. The specific ordering of method steps is however given for illustrative purposes only and should not be construed as binding.

Please note that the division of the ToF system 10 or 20 into units 101 to 156 is only made for illustration purposes and that the present disclosure is not limited to any specific division of functions in specific units. For instance, the ToF system(s) could be implemented by a respective programmed processor, field programmable gate array (FPGA) and the like.

The methods discussed herein can also be implemented as a computer program causing a computer and/or a processor, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Time-of-flight circuitry for determining a roundtrip delay of photons emitted by a light source and incident on a time-of-flight imaging element, the time-of-flight circuitry being configured to:
   determine a test number of photons at a test point of time and a reference number of photons at a reference point of time, the test point of time and the reference point of time being included in a measurement time interval of at least two measurement time intervals for which the test point of time is varied; and
   compare, for determining the roundtrip delay of the emitted photons, the test number of photons with the reference number of photons.
(2) The time-of-flight circuitry of (1), wherein the test number of photons is indicative of the emitted photons.
(3) The time-of-flight circuitry of (1) or (2), wherein the reference number of photons is indicative of ambient light.
(4) The time-of-flight circuitry of anyone of (1) to (3), wherein the test number of photons is either zero or one.
(5) The time-of-flight circuitry of anyone of (1) to (4), wherein the test point of time is based on a test gate signal which constitutes a test time interval and wherein the reference point of time is based on a reference gate signal which constitutes a reference time interval.
(6) The time-of-flight circuitry of anyone of (1) to (5), further configured to:
   change a confidence value based on the comparison of the test number of photons with the reference number of photons.
(7) The time-of-flight circuitry of (6), further configured to:
   increase the confidence value, if the test number of photons is larger than the reference number of photons; or
   decrease the confidence value, if the reference number of photons is larger than the test number of photons.
(8) The time-of-flight circuitry of (6) or (7), further configured to:
   determine the roundtrip delay if the confidence value exceeds a predetermined threshold.
(9) The time-of-flight circuitry of anyone of (1) to (8), further configured to:
   vary the test point of time, if the test number of photons is below a predetermined threshold.
(10) The time-of-flight circuitry of anyone of (1) to (9), wherein the time-of-flight imaging element is based on a single photon avalanche diode.
(11) The time-of-flight circuitry of anyone of (1) to (10), further including a switched capacitor averaging circuit including an averaging capacitor, a sampling capacitor, and a switch for switching between the averaging capacitor and the sampling capacitor, for comparing the test number of photons with the reference number of photons.
(12) The time-of-flight circuitry of (12), wherein the switched capacitor averaging circuit is configured to carry out exponential moving averaging based on a ratio between an averaging capacitor capacitance and a sampling capacitor capacitance.
(13) A time-of-flight method for determining a roundtrip delay of photons emitted by a light source and incident on a time-of-flight imaging element, the method comprising:
   determining a test number of photons at a test point of time and a reference number of photons at a reference point of time, the test point of time and the reference point of time being included in a measurement time interval of at least two measurement time intervals for which the test point of time is varied; and
   comparing, for determining the roundtrip delay of the emitted photons, the test number of photons with the reference number of photons.
(14) The time-of-flight method of (13), wherein the test number of photons is indicative of the emitted photons.
(15) The time-of-flight method of (13) or (14), wherein the reference number of photons is indicative of ambient light.
(16) The time-of-flight method of anyone of (13) to (15), wherein the test number of photons is either zero or one.
(17) The time-of-flight method of anyone of (13) to (16), wherein the test point of time is based on a test gate signal which constitutes a test time interval and wherein the reference point of time is based on a reference gate signal which constitutes a reference time interval.
(18) The time-of-flight method of anyone of (13) to (17), further comprising:
   changing a confidence value based on the comparison of the test number of photons with the reference number of photons.
(19) The time-of-flight method of (18), further comprising:
   increasing the confidence value, if the test number of photons is larger than the reference number of photons; or
   decreasing the confidence value, if the reference number of photons is larger than the test number of photons.
(20) The time-of-flight method of (18) or (19), further comprising:
   determining the roundtrip delay if the confidence value exceeds a predetermined threshold.
(21) The time-of-flight method of anyone of (13) to (20), further comprising:
   varying the test point of time, if the test number of photons is below a predetermined threshold.
(22) The time-of-flight method of anyone of (13) to (211), wherein the time-of-flight imaging element is based on a single photon avalanche diode.
(23) The time-of-flight method of anyone of (13) to (22), further comprising switching between an averaging capacitor and a sampling capacitor for comparing the test number of photons with the reference number of photons.
(24) The time-of-flight method of (23), further comprising carrying out exponential moving averaging based on a ratio between an averaging capacitor capacitance and a sampling capacitor capacitance.
(25) A computer program comprising program code causing a computer to perform the method according to anyone of (11) to (20), when being carried out on a computer.
(26) A non-transitory computer-readable recording medium that stores therein a computer program product, which, when executed by a processor, causes the method according to anyone of (11) to (20) to be performed.

1. Time-of-flight circuitry for determining a roundtrip delay of photons emitted by a light source and incident on a time-of-flight imaging element, the time-of-flight circuitry being configured to:
determine a test number of photons at a test point of time and a reference number of photons at a reference point of time, the test point of time and the reference point of time being included in a measurement time interval of at least two measurement time intervals for which the test point of time is varied; and
compare, for determining the roundtrip delay of the emitted photons, the test number of photons with the reference number of photons.

2. The time-of-flight circuitry of claim 1, further including a switched capacitor averaging circuit including an averaging capacitor, a sampling capacitor, and a switch for switching between the averaging capacitor and the sampling capacitor, for comparing the test number of photons with the reference number of photons.

3. The time-of-flight circuitry of claim 2, wherein the switched capacitor averaging circuit is configured to carry out exponential moving averaging based on a ratio between an averaging capacitor capacitance and a sampling capacitor capacitance.

4. The time-of-flight circuitry of claim 1, wherein the test number of photons is either zero or one.

5. The time-of-flight circuitry of claim 1, wherein the test point of time is based on a test gate signal which constitutes a test time interval and wherein the reference point of time is based on a reference gate signal which constitutes a reference time interval.

6. The time-of-flight circuitry of claim 1, further configured to:
change a confidence value based on the comparison of the test number of photons with the reference number of photons.

7. The time-of-flight circuitry of claim 6, further configured to:
increase the confidence value, if the test number of photons is larger than the reference number of photons; or
decrease the confidence value, if the reference number of photons is larger than the test number of photons.

8. The time-of-flight circuitry of claim 6, further configured to:
determine the roundtrip delay if the confidence value exceeds a predetermined threshold.

9. The time-of-flight circuitry of claim 1, further configured to:
vary the test point of time, if the test number of photons is below a predetermined threshold.

10. The time-of-flight circuitry of claim 1, wherein the time-of-flight imaging element is based on a single photon avalanche diode.

11. A time-of-flight method for determining a roundtrip delay of photons emitted by a light source and incident on a time-of-flight imaging element, the method comprising:
determining a test number of photons at a test point of time and a reference number of photons at a reference point of time, the test point of time and the reference point of time being included in a measurement time interval of at least two measurement time intervals for which the test point of time is varied; and
comparing, for determining the roundtrip delay of the emitted photons, the test number of photons with the reference number of photons.

12. The time-of-flight method of claim 11, further comprising switching between an averaging capacitor and a sampling capacitor for comparing the test number of photons with the reference number of photons.

13. The time-of-flight method of claim 12, further comprising carrying out exponential moving averaging based on a ratio between an averaging capacitor capacitance and a sampling capacitor capacitance.

14. The time-of-flight method of claim 11, wherein the test number of photons is either zero or one.

15. The time-of-flight method of claim 11, wherein the test point of time is based on a test gate signal which constitutes a test time interval and wherein the reference point of time is based on a reference gate signal which constitutes a reference time interval.

16. The time-of-flight method of claim 11, further comprising:
changing a confidence value based on the comparison of the test number of photons with the reference number of photons.

17. The time-of-flight method of claim 16, further comprising:
increasing the confidence value, if the test number of photons is larger than the reference number of photons; or
decreasing the confidence value, if the reference number of photons is larger than the test number of photons.

18. The time-of-flight method of claim 16, further comprising:
determining the roundtrip delay if the confidence value exceeds a predetermined threshold.

19. The time-of-flight method of claim 11, further comprising:
varying the test point of time, if the test number of photons is below a predetermined threshold.

20. The time-of-flight method of claim 11, wherein the time-of-flight imaging element is based on a single photon avalanche diode.
